(19) United States
(12) Patent Application Publication
(10) Pub. No.: US 2009/0115368 A1
(43) Pub. Date: May 7, 2009

(54) Distributed electric power generation

(76) Inventor: James Kenneth Bullis, Sunnyvale, CA (US)

Correspondence Address: James K. Bullis, 1155 Pimento Ave., Sunnyvale, CA, 94087, US

(21) Appl. No.: 11/983,192

(22) Filed: Nov. 7, 2007

(51) Int. Cl. H02J 7/14; B60L 11/00; H02J 7/32

(52) U.S. Cl. 320/101; 290/2; 320/109

(57) ABSTRACT

An electric power generating system is arranged such that the system efficiency approaches 100%. In the context of this special arrangement, system efficiency is defined as the electrical energy produced divided by the amount of heat energy allocated to its production. All heat energy that is not converted to electric energy is completely used by an associated household. However, high efficiency requires that heat usage by the household is not increased as a result of this arrangement. Unlike most electric power generation, heat is not wasted, so there is no inefficiency.

The motor vehicle includes an electric generator driven by a heat engine, with an optional natural gas connection to the household. The heat from the exhaust and the engine coolant is connected to household devices that make full use of that heat. As needed, operation of the heat engine is regulated such that heat discharge rate does not exceed the rate at which household devices can use that heat. Generated electricity charges vehicle batteries, with surplus going to the household and to the public utility.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to electric power generation systems and motor vehicles.

2. Description of the Prior Art

Effective personal transportation design involves a number of requirements. Global warming has become an issue such that the rate of carbon dioxide emission is now a high priority consideration. The fact that world fuel supplies are being depleted and, accordingly, the cost of fossil fuels is going up, along with the international problems that are arising as a result of the oil and gas economy, means that energy efficiency is still an important priority. Safety is an underlying requirement for transportation systems. For a means of transportation to be acceptable to the public, it must also provide comfort and personal satisfaction with the process. The importance of transportation speed is an important quality of life factor that is quite often overlooked in planning of transportation systems. The public has strongly demonstrated by personal choices that living and working in a distributed, suburban like, community is strongly preferred over more compact urban arrangements. In this setting, speed of transportation is of special importance, since the distances covered in daily travel are significant. Public policy in a democratic society should clearly support these priorities. And success of newly invented systems depends on how well such invented systems respond to them.

The above priorities strongly motivate the individual personal car, with the provision that efficiency and the emissions priorities are satisfied. The conventional automobiles that now exist in large numbers fail to meet these efficiency and emissions priorities, but patent application Ser. Nos. 11/064,301 (published) and 11/893,497 show appropriate solutions that meet all the requirements. Some design issues still remain.

In the course of choosing the propulsion system for these concepts, it was found that the relative merit of systems was not as simple to determine as originally expected. It was originally expected that the primary consideration would be energy efficiency. A meaningful comparison of vehicles can be done on the basis of efficiency if the heat equivalent of fuel used as a result of car operation is correctly determined in each case. It is then meaningful to talk of miles per unit of heat energy, and a reasonable unit of heat energy is the gallon of gasoline. However, the amount of carbon dioxide released into the atmosphere as a result of operating that car is not necessarily a simple function of energy efficiency. Because the rate of carbon dioxide emission is now the critical criterion for deciding how to provide for our transportation needs, this subject needed further study.

The previously invented vehicles are naturally suited to a system where mechanical energy at the car wheels comes from electric motors that are powered by electric energy that is stored in batteries, where the energy stored in batteries is produced by an electric utility system. These are called “plug-in” electric since the batteries are charged by plugging them in to connect them to the electric utility network. Compared to conventional automobiles having the same shape and weight, there is a conceivable improvement in efficiency due to efficiency of electric energy generation that the electric power station can achieve. The reality is that power stations burning fossil fuels in the United States in 2007 converted energy from fossil fuel into electrical energy with an efficiency of 34%. It might be said that other power sources such as hydro, wind, geothermal, solar, or nuclear are more efficient in one way or another. We can be quite certain that energy from these sources is fully allocated to the present electrical demands of the country. Thus, the capacity to meet any additional need is in those fossil fuel fired power plants. Therefore, the efficiency of 34% for basic electric power generation along with the distribution, battery charging, and motor efficiencies must be compared to the conventional automobile system where a mobile heat engine delivers mechanical energy through a mechanical drive train. When a complete analysis is done, it can be seen that the electric efficiency advantage is not a lot.

Our problem is much worse. It might seem that there is an advantage in the lack of air pollution that is caused by the electric cars, since air pollution coming directly from these is small. Of course the indirect pollution by the power plant must be allocated to the electric car even though the pollution might occur in a far away location. Now that we understand the global warming mechanism of carbon dioxide, where we once thought electric cars would be a good environmental choice, it now is clear that they are not, at least in the present power system configuration.

The problem is coal, even though it is now possible to clean much of the health damaging pollutants from the exhausts, the carbon dioxide that is a natural component of air has been shown to be far out of balance. Much of this comes from the electric power generation process. The worst form of fossil fuel is coal, where coal puts out twice as much carbon dioxide as does natural gas, for the same output of electric energy. Further, the cost of a kilowatt-hour of electricity made from natural gas is about three to five times as much as the cost of that unit of electricity made from coal. To change from coal to natural gas, we are looking at doubling or tripling of electric bills, for simply meeting our current needs for electricity. Even with large subsidies it does not appear that solar or wind alternatives are likely to make much difference. The cost of the subsidies is a further burden on the consumer, and although it is not widely protested now, if these methods are widely implemented, the cost will be staggering, as will be the objections.

If electric cars were to be added to the existing load on the electric power system, the problem would be greatly exacerbated. Proponents of electric cars point out the fact that the natural time for charging these is at night, when low electric rates can potentially be negotiated. A reason for low rates late at night is that the general demand for electricity is then low. Unfortunately there appears to be another reason, which is that electricity generated at night is largely from coal. Any incremental increase in use of electricity at night can be expected to come entirely from coal, since the desirable forms of solar and wind sourced electricity are not then available and hydro power is sensibly turned off to hold in reserve for daytime use. Nuclear and geothermal may continue through the night, but such outputs are fully allocated such that these can not respond to an incremental increase in power demand. Coal fired power generation can and will meet the incremental need. Therefore, although there might be an efficiency advantage in an electric car, if the standard of comparison is the amount of carbon dioxide attributed to operation of that electric car then the electric car fails in comparison to a conventionally powered automobile that is of the same general design.

If most people could be forced into an urban lifestyle that would enable effective rail transportation, then much of the problem would be solved. A much more attractive plan is enabled by high efficiency vehicles, where the amount of energy required to move that vehicle rapidly between distributed starting points and destinations is greatly reduced. Such a vehicle is the Miastrada, which is the subject of previously mentioned patent application Ser. Nos. 11/064,301 (published) and 11/893,497. Being what appears to be a very efficient aerodynamic design, the Aptera seems to be a viable competitor. Such vehicles greatly reduce carbon dioxide emissions, regardless of the means by which they are propelled. However, it is not appropriate to waste this advantage.

As previously noted, the Miastrada concept is naturally suited to being driven by electric motors, but there is an option to the plug-in electric arrangement. Instead of batteries that are charged at night from public utility sources, it can be configured so that batteries are charged with a built in auxiliary heat engine driving an electric generator. Note that because of the basic efficiency of this vehicle and because of the load averaging effect of the batteries, this auxiliary engine is much smaller than the heat engines in conventional automobiles. This latter option has much in common with the popular hybrid arrangement. Compared to the plug-in electric form, the mobile auxiliary engine arrangement enables the battery capacity to be less and the travel distance to be indefinite. Weight comes out about the same, but the plug-in electric form is somewhat less expensive. Considering only energy efficiency, the plug-in arrangement is superior, especially since the high efficiency of the vehicle enables a travel range using only battery stored energy is sufficient for most commuter needs. However, using the carbon dioxide emission criterion, the advantage tilts in favor of the mobile auxiliary choice, since the probable fuel source of electric energy for the plug-in system that is charged at night is coal. Unfortunately, the cost advantage goes to the choice that is the wrong answer from the global warming point of view.

The challenge then is to improve efficiency of the auxiliary engine arrangement such that the cost advantage for the wrong answer is minimized, or better still, reversed. If we assume that high efficiency vehicles are widely adopted, we have an opportunity to rethink how we operate in other ways as well. Although it might make sense to tax the coal supply so as to shift the balance, it is preferable to find a technological solution that motivates the better course of action.

For a clear perspective, the very efficient motor vehicles being referred to here are about four times more efficient than the Toyota Prius and about eight times more efficient than the typical American car. The recently disclosed vehicle concepts are capable of providing an important transportation need of most families, with safety, comfort, convenience, and personal satisfaction. They are producible at a low cost. Further, they use much less space on the road and in parking lots. The task is to motivate adjustment of people to a new form of car, where people sit in tandem rather than side-by-side.

It is important to undertake the difficult task of changing people's perception of how they must sit in cars, because the narrow car that is enabled by tandem seating is so very important for vehicle efficiency. Hopefully, as people realize that the fuel cost with such an efficient vehicle is almost negligible, the traditional requirement for side-by-side seating will be recognized as a wasteful frill. As fuel becomes more expensive, the narrow car will seem yet more attractive, since the alternative is riding in public transportation. Other benefits will be recognized as well, such as the ability to park in a half sized parking space. The result is expected to be a widespread pattern, where at least one high efficiency vehicle is associated with each single-family household. And in a large number of cases, each such household will then have a small power generation unit parked in its proximity for an overall total time duration that is a significant fraction of a day.

The small engines needed are notable in their much lower heat output. While it is anticipated that the small engines can be made more thermally efficient than engines in most cars today, the bigger comparative difference is their relative output power rating. A full order of magnitude, that is, one tenth, reduction is expected in the power output rating of the heat engines appropriate for the high efficiency vehicles, compared to that power output rating appropriate for typical production automobiles. Wasted heat output that is similarly reduced. Engine efficiencies relate to the expected waste heat output, but such efficiencies will probably vary within a range from 20% to 35% such that this is expected to be a secondary effect compared to the larger effect of the order of magnitude reduction in vehicle power requirement. Thus, a very different sort of engine will be present in proximity to a typical household.

A power generation process called cogeneration is well known. It depends on the large power generation system being located in proximity to a user of heat. Because of the equipment costs and the magnitude of heat involved such arrangements are relatively uncommon. Under the present day circumstances there are more of these arrangements being made, though industrial systems and commercial establishments seem to be the extent of the application of this cogeneration operation. Even where it is practiced, the process is not necessarily highly efficient since there are limits to the times when production of heat in the electricity generation process is matched to the need for heat by the heat using establishment.

There is other relevant equipment to be noted. Air conditioning apparatus known as absorption chillers are presently in use, mostly in large-scale commercial and industrial establishments. For household sized purposes refrigerators that are operated with heat as power sources are available. Heat storage devices have been discussed that utilize phase change material to store a significant amount of heat for later use, where the amount of heat stored is a result of the heat of fusion effect.

There are various ways that distributed power sources now relate to the public utility network. Pacific Gas and Electric Company has announced a trial program to tap into electric power stored in batteries in electric vehicles when the power network is in short supply. Also, public utilities are required under various regulatory requirements to buy power generated by solar cell devices and by wind turbine devices. The prices that they are required to pay appear to be at a rate that is much higher than the rates that consumers are charged. Public utilities subsidize the capital costs of very expensive solar cell installations, including cost of equipment that interfaces safely with the power grid. The costs of such are passed on to the power customers, and are listed as a line item called “public programs” on an example electric bill.

### SUMMARY OF THE INVENTION

Here disclosed is a distributed power generation system based on high efficiency, electrically driven road vehicles that are regularly parked in proximity to respective households. Heat that is discharged from operation of low powered heat engines driving electric generators in these road vehicles is transferred to the respective households where heat is fully used. Key to the efficiency of this system is the relatively small engine that is operating at low power, with associated low heat production. The system efficiency is nearly ideal as long as the amount of discharged heat is less than the requirement of the household for heat. The indicated engine size is expected to become widely available when high efficiency road vehicles equipped with such engines are widely accepted. Adaptation for this dual use of motor vehicle equipment as stationary electrical generating systems requires only slight added cost.

The nearly ideal system efficiency comes about because discharged heat, otherwise wasted, is now captured to be used by the household. It replaces heat that would otherwise have come from burning fuel within the household. Insulating methods minimize loss of heat prior to arrival in the household.

The capability to use heat without waste is adequate in northern climates in the colder months. A heat storage device is included to accommodate the fact that the capability to use heat is not necessarily at the same time as the road vehicle is present to generate that heat. This is constructed as a tank holding phase change material with heat transfer enabled by coiled tubing therein. Use of heat in warm climates and seasons is enabled by use of heat driven, absorption chiller devices instead of electric air conditioners and refrigerators.

The electric energy output of each mobile generator is available for use in charging batteries in the electric vehicle, for operating household equipment, and for distribution beyond an individual household through the public utility power grid.

The mobile heat engine is adapted with a valve to enable use of natural gas from the household during operation when the vehicle is parked.

### BRIEF DESCRIPTION OF THE DRAWINGS

FIG. 1 Distributed electric power generation system.

FIG. 2 Motor vehicle and household apparatus with example connections and heat using devices.

FIG. 3 Energy allocation diagram illustrating concept of electric power generation at 100% system efficiency.

### DETAILED DESCRIPTION OF THE PREFERRED EMBODIMENT AND VARIATIONS

The high efficiency, narrow vehicle concept of the previously mentioned inventions does much to satisfy the requirements for a transportation system that fits with the distributed living and working choice of the public. Based on the high efficiency vehicle, a complementary arrangement has now been worked out where a system of power generation associated with that transportation system results in reduced carbon dioxide emissions as well as reduced use of fossil fuel in general. Because vehicles are distributed, a distributed power generation system is possible. This distributed power system supports the gains to be made with the high efficiency vehicles by assuring that the source of electricity is not detrimental to the environment, as well as highly efficient in use of resources. There is even an overflow effect where efficiently generated electric power that is surplus to the vehicle needs is available for household use and for use in the electric utility distribution network. In this plan there is real hope for ending global warming as well as greatly extending the life of fuel resources of the world.

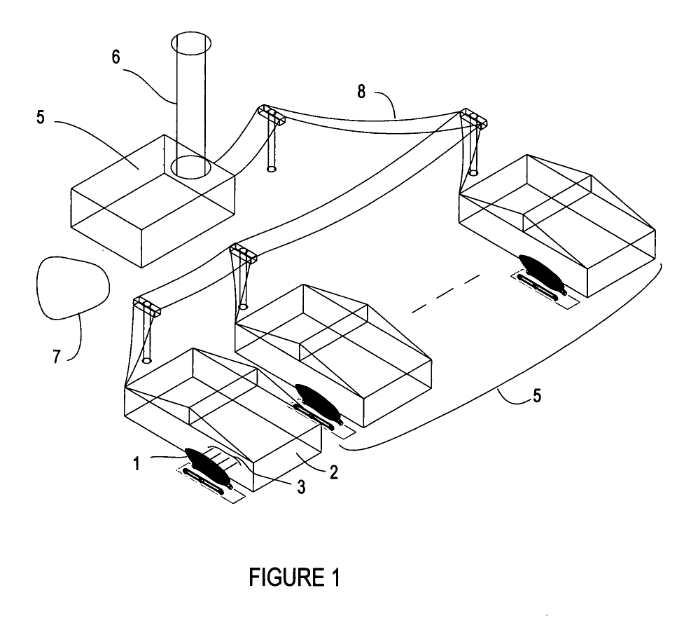

FIG. 1 shows the distributed electric power generating system. The basic unit of the system is the high efficiency vehicle 1 parked in proximity to a household 2. Connections for natural gas, hot engine exhaust, and hot engine coolant and its return, and electric power transfer are shown as a collection 3 in this illustration. The distributed aspect of the system is indicated by the sequence 5 that repeats the form of the basic unit. The households such as the first household 2 are all connected to the electric power distribution system 8, which is in turn connected to the central power plant 5. The public utility also provides natural gas as a basic fuel to the households. This fuel is passed on to the vehicle. The power plant facility includes a smokestack 6 and a cooling water pond 7 as an example arrangement.

The potential benefit of the invented system would provide a large amount of electrical power in such a way that the fossil fuel burned by the country would be significantly reduced. Under the conditions here described, the capital investment in equipment and real estate to produce this electricity would be much less than that required for a similar reduction in fossil fuel burned due to investment in solar systems. The unique combination here described is expected to fit into the preferred lifestyle of most people with very minor change in the way they do things.

The distributed electric power generating system operates in a way that makes the usual way of thinking about heat engines inappropriate, at least in the described context. The usual thinking is that the heat engine produces mechanical energy and throws away heat. The thermal efficiency of such an arrangement is always very disappointing. If we can get over the idea that electric power has to be generated in a central station and distributed by power lines, we can begin to think of system efficiency that is 100%. This equates to a system efficiency factor of one. By thinking of electrical generation in context of a distributed system, where heat is effectively used, the system efficiency factor is exactly one, where that system efficiency factor is defined as a heat equivalent of electric energy generated by operation of a heat engine over a time interval divided by a difference of heat produced in that heat engine over that time interval and said excess of heat produced over said time interval. While this is a contrived definition that has to give a system efficiency factor of one, it is intended to demonstrate the point of this invention. It is common to think of electricity being produced and distributed with a distribution loss. If we think of heat in the same way, that is, it is produced and delivered for use in a household, then the heat engine becomes a loss free apparatus that simply produces two commodities from the heat burned. Philosophically, it seems that we have become accustomed to abundant fuel such that it has been simply accepted that the right way to do things is to produce an electric power commodity at a central station and throw away the heat commodity. It is not. Especially where and when it is possible to do differently.

With the automobile, the options to use excess heat after generation of electricity are limited, although we might start to think about car air conditioning that is based on the heat driven absorption method that is discussed later for use as household air conditioning. This is potentially much better than the present method where mechanical energy is taken from the engine to drive the air conditioning compressor. In mobile situations, this is a requirement for heat such that use of heat for this purpose is a valid way to improve system efficiency. For the size of engine in the high efficiency vehicle, this use of heat can be of magnitude that has a noticeable impact. It would be better to run the automobile air conditioner this way than to use mechanical or electrical energy. Heat from engines is almost universally used to warm automobiles in cold weather. In this case the savings is the fuel that would otherwise be needed to heat the car in an independent heating device. This can be said to increase system efficiency, though the amount of heat used is so small in respect to conventional car engine heat outputs, that it is barely noticeable.

The here invented power generation system based on dual use of a plurality of high efficiency, electrically propelled road vehicles where these are equipped with batteries and an electric generator driven by a heat engine. In each vehicle, the electric energy output of the mobile, engine driven generator is needed for long distance operation of the vehicle, where battery storage of energy becomes impractical. The required generator output is determined by the low energy needs of the road vehicle, as is the power output requirement for the engine. In this system a vehicle is parked in proximity to a household, with provision for heat discharged from operation of its small heat engine to be transferred to a household where that heat is fully used. High efficiency of this system requires that the amount of discharged heat is less than the requirement of the associated household for heat. An engine rating that is reasonably matched to this system is in the 10 to 20 hp range, or less, where this size engine can be made to operate efficiently while producing a moderate amount of heat that will meet this requirement on a significant number of days in a year. This indicated engine size is expected to become widely available when high efficiency road vehicles equipped with such engines are widely accepted. Adaptation for a dual use as stationary electrical generating systems requires only slight added cost.

While the very high efficiency vehicle that requires only a very small engine is strongly favored, there are many circumstances where a larger vehicle has an important purpose in family transportation. Large cars that are now widely used are being re-designed as hybrids that will have electric energy production capability. Where such cars continue to be large, and engines in these cars are also still large, there are problems with loading of such engines at a level where the engine is efficient without causing a heat output that exceeds the capacity of a household to use that heat output. In some situations this problem can be dealt with though intermittent operation. Such intermittent operation would involve running the engine for time intervals that are interspersed with time intervals where the engine is turned off. The time average of the power output would then be a fraction of the power output during the on times. By adjusting the on time duration and the off time duration a time average of heat production can be made to fit into the household heating requirements. This engine, with its operation thus regulated, would have average heat and power outputs like a small engine system. This averaging strategy is meaningful for matching heat output with heat usage requirements of a household for any sized vehicle used, though the peak heat output must be somehow captured in full and the on and off cycling must not be a cause of inefficiency. The full benefit of this system is not as easily realized with large cars since such full benefit entails carrying sufficient batteries in the car to take advantage of the very inexpensive electricity that is produced by this distributed electric generating system.

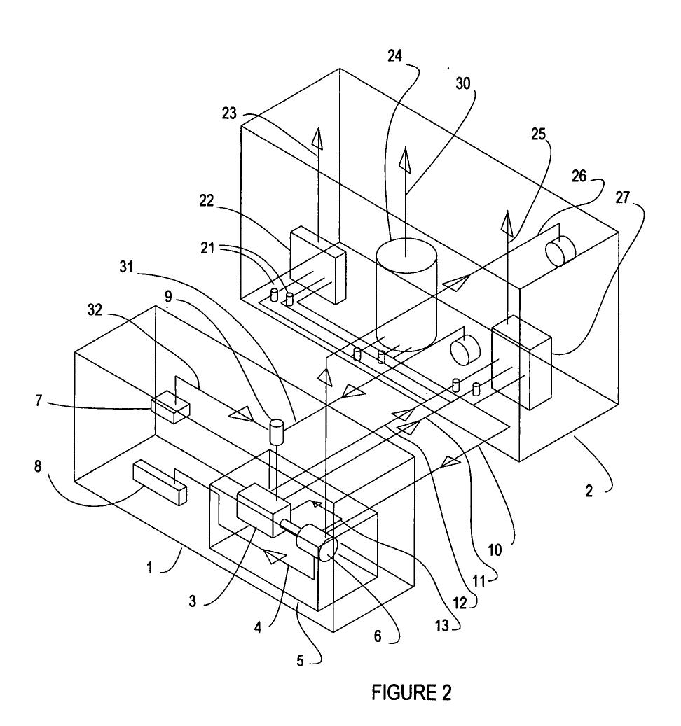

As depicted in FIG. 2, the adaptation entails pipes, tubing, valves and connecting devices as well as electrical wiring and connection devices. The relevant vehicle equipment is within the box 1 that represents the vehicle. The heat using household is represented by the box 2. The small heat engine 3 in the vehicle drives the generator 6 which produces electric energy that is delivered 4 to the vehicle batteries 8 and delivered 26 to the household electric system which is connected to the utility distribution grid. The vehicle includes a gas tank 7 for gasoline with tubing to deliver that gasoline to the fuel switching apparatus 9 that also receives natural gas through tubing 31. The fuel switching apparatus 9 would typically switch to gasoline for mobile operation, to be used when battery energy is drained. When parked it would switch to natural gas operation. The mobile fuel could also be compressed natural gas from the appropriate form of the tank 7 shown. Automatic shut-off connectors would be included in the natural gas transfer apparatus 31. Hot exhaust, which would be let out through a tail pipe in mobile operation, is transferred through an insulated pipe 12 that is connected to the household heat using devices. Engine coolant that would be routed through a vehicle radiator is routed through tubing 11 to household devices with a return 10 that runs relatively cool coolant through the generator 6 heat exchanger and then routed 13 back to the engine 3. Example heat using devices shown are an absorption cooling unit 22 for air conditioning of the household space, a hot water heater 24, and a radiator 27 for heating of the household space. The cooling unit could also be a heat driven refrigerator. A feature included in the indicated cooling unit is the capability to make ice such the capacity to use heat at one time can be translated into a cooling device at a later time, thus expanding the usefulness of this system. The radiator could be a heat exchanger in a typical furnace duct. Where these devices use hot engine exhaust, vents 23,30,25 are appropriate, just as vents are now present for heat using devices that directly burn natural gas. This all represents a system that must be designed to handle heat effectively. This entails valves that are controlled such that heat usage is coordinated with vehicle engine operation. Efficiency requires that heat from the vehicle is completely used. The operation of the vehicle engine is arranged to enable control of that operation to match heat production timing with timing of heat needs.

The absorption chiller, whether for air conditioning or refrigeration purposes represents a significant adaptation relative to most households. Such devices are important to extend benefits of this to summer time operation. Where this is done the heat that is displaced, such that is unnecessary to burn fuel to heat it, represents heat that would have otherwise been produced in the central power station for purpose of generating electricity that then powers the electric air conditioner and the electric refrigerator. It is assumed here without further analysis that the usage of heat by the household that comes from the vehicle is roughly comparable to the heat that is saved by making it unnecessary for the power plant to burn fuel to make that no longer needed heat. Even if this is not a very accurate assumption, a significant net gain in efficiency is still expected, and this gain will come about even in warm climates and seasons.

The main cost item, being the engine 3, is basically unchanged from its independent form. It is anticipated that this use of the engine would eventually drive development of a more durable engine capable of sustained operation. As mentioned, heat transfer losses slightly reduce efficiency, but these are minimized by insulation of the heat engine, the generator, and the pipes and tubing that carry the heat. Heat transfer involves both exhaust heat and heat extracted using engine coolant. The exhaust temperature is by far the highest of these. A simple example use of this is in hot water heating, where it would replace the natural gas burner in that appliance. The engine coolant would drive lower temperature equipment such residential heating equipment such as radiators. The return coolant would cycle first through a heat exchanger that would help cool the electric generator and then continue through the heat engine and back to the household. By design of an insulating compartment that contains both the generator and the engine, virtually all the heat available would be captured. This compartment would be opened for road operation.

Where electrical connection is made to the ac circuits of the household and to the electrical grid, there is a requirement for electronic equipment that puts the electrical power into proper form for these purposes. Engineering techniques that are required for such adaptation are known in the field of power electronic devices. Techniques used to design apparatus in connection with solar panel operation are similar to those required here.

Although it is not essential for this system to work, it is anticipated that heat engines would be refined over time to make them more durable as well as more efficient. Greater efficiency is known to be possible where a heat engine is operated under constant load at a constant speed. It is also known to construct heat engines for industrial or agricultural purposes, where long term, sustained operation is needed.

A strategy for use of the electric power generated when attached to the household would be to make it first available for charging batteries in the electric vehicle. This would assure that vehicle operation would be extremely efficient. Because there is no burden of waste heat, the heat to produce the electric energy used through the battery intermediary is only its thermal equivalent in energy. A car that uses a gallon of gasoline to go 200 miles when running directly from the on board system, would now use an amount of natural gas having a heat equivalence of a gallon of gasoline to go as far as 600 miles.

After charging automobile batteries, the remaining energy generated would be available for operating household equipment and for distribution beyond an individual household through the public utility power grid. Assuming natural gas is provided through the household to be the fuel source for the small heat engine, a direct comparison can be made to the efficiency of the public utility system. In the United States, the efficiency of electricity generation by natural gas fired plants was 34% in 2005. Under the prescribed conditions, the invented system will produce electricity at approximately 100% system efficiency, so it could be described as a “buy one, get two free” deal. The public utility is still worse if distribution losses are taken into account. In the invented system, much of the energy is used close to where it is made. It must be noted that this depends on full utilization of the heat by the household and on ideal heat transfer. It also depends on the household not expanding its heat usage in light of the new economy that will show on the utility bill for that household. The natural gas charges will actually go up, but the electric charges will much more than make up for that increase.

By this strategy of operation, the reduction in use of coal as a fuel to make electricity can be maximized. First, by using natural gas to run the car heat engine and using the produced electricity to charge the car batteries, it can be assured that no coal is used for this purpose. Second, any excess power fed back into the grid will also come from a natural gas source. Because of the system efficiency as defined here, the cost of production of that exchanged electric energy is about a third of the cost of electricity produced in central power stations burning natural gas. Conceivably, power companies will take a major role in establishing this system, in which case it would be reasonable for them to take part of the benefit of this efficiency. Hopefully, this will be a low cost power source that will make it easier for the power company to reduce usage of coal facilities. It might be sufficient motivation to the household owner that his car batteries will be charged at very low cost, though it seems appropriate that benefit from the low cost of the exchanged electricity should be partly left to the household owner as a further motivation. And third, to the degree that this system operates at night, coal usage can be impacted the most. An accurate analysis has not been done, but something like 10% to 20% reduction in coal use is considered to be possible through this distributed power generation method.

Clearly the benefits of this system relate to climate. In months when very little need exists for heating or air conditioning, the amount of electrical power that will be generated at the ideal efficiency is limited. In such months, water heaters and heat powered refrigerators would appear to be the main users of discharged heat, so there will still be some dependence on central power stations for electric energy.

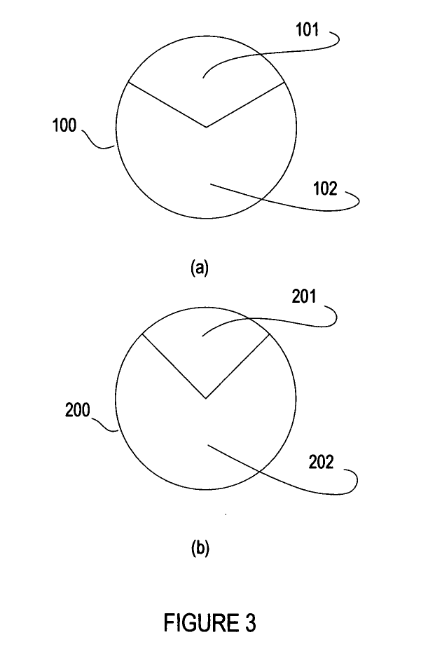

FIG. 3 is a graphical depiction of system efficiency, shown comparatively for the conventional central power station approach (a) and the distributed system (b). The circles 100,200 represent the respective heat generated by burning fossil fuel. The part of the heat energy that is translated into electric energy is represented by the smaller sectors 101,102 of the respective circles. These smaller sectors differ slightly in size, but the far more important effect is the way the heat represented by the larger sectors 102,202 is handled. The central power stations that are now the source of most electric power waste the heat that is not translated into electricity by discharge into the smokestack 6 or cooling water 7 as depicted in FIG. 1. In contrast, heat not directly translated into electricity in the distributed system is a useful product that benefits the household. From a different point of view, the household currently burns fuel; in the new approach, it draws some additional natural gas over its current usage amount, where this additional natural gas is entirely translated into electric energy. This is made effective because of the specific arrangement where both as much as possible of the current usage fuel and the additionally drawn fuel are burned in the heat engine in the motor vehicle. The discharged heat is then transferred into the household where it is used as if it were a result of burning that fuel in the household. The household devices that use heat only need for that heat to be at a relatively low temperature; this is significantly lower than the initial temperature present in the heat engine. This fact makes this system workable.

FIG. 3 shows the amount of electricity produced in a central power station from a unit of heat to be greater than that produced in a mobile vehicle heat engine. Although this is not a critical comparison it does need some attention. The utility power station system requires a distribution system, which loses 7% of energy transferred. This loss is also wasted heat. This is a handicap that is not applicable where the generator is close to the user of the electricity, whether it be the vehicle itself for charging batteries, or for use by household electrical devices. Engines in the central power stations vary, but the national average for their efficiency is surprisingly low. On the other hand, while automotive engines are not as efficient as desired, there is an opportunity for significant improvement for engines where the loading is constant. Such loading can be achieved for the operation of running the generator as described here. Such improvements have been reported in the Toyota Prius engine where it is operated at selected loads.

FIG. 3 shows how the definition of system efficiency used here has to be 100%, since the output energy is equal to the input energy. For the central power plant, the discharged heat energy is not a useful output. The traditional definition of thermal efficiency accepts the idea that the discharged heat is wasted.

Use of discharged heat is an existing, but relatively infrequent, practice. Where it is done, it is usually on a larger industrial or commercial scale where the machinery cost is a capital expense that is practical. Appropriate opportunities have not been sufficiently common that a significant fraction of power is produced on this basis. The opportunity to make a major change comes from the relatively small power plants that are anticipated in context of the high efficiency motor vehicle system, where the machinery cost is mostly covered in the cost of the motor vehicle.

The capability to use heat is adequate in northern climates in the colder months. A heat storage device is included to accommodate the fact that the capability to use heat is not necessarily at the same time as the road vehicle is present to generate that heat. This is constructed as a tank holding phase change material with heat transfer enabled by coiled tubing therein. Use of heat in warm climates and seasons is enabled by use of heat driven, absorption chiller devices instead of electric air conditioners and refrigerators. This is a known technology, though typical chillers are built on an industrial scale. The Servel refrigerator has long been known. This is a household sized appliance operating on the same principle. It is anticipated that heat driven air conditioners, if not already designed, will be soon designed. The Servel refrigerator is capable of efficient operation on natural gas, propane, or heat from electricity. As such, it represents a concept having flexibility that is anticipated to be useful in managing the heat usage schedule and power generating schedule. The actual household equipment must be designed in relation to both the peak and the average heat output of the heat engine.

Development and operation of this power generation system is anticipated to take place over time, where people get used to new ways of thinking about energy. Government now is deeply involved in public utility regulation, and this has extended to giving incentives through the public utilities to people who change appliances or install solar related energy systems. Government restricts the emissions from engines of all types. It also provides incentives to companies to produce oil through tax credits, including an oil depletion allowance that reduces oil company taxes. Much needs to be adjusted to lead to a more efficient energy usage pattern in order to slow the rate that we consume resources and to reduce the amount of carbon dioxide that is released into the air. The high efficiency car is an electrical system that is anticipated to fit into the emerging system. The present invention is expected to complement that car concept by enabling much improved power generation such that such a car draws from efficiently produced electricity.

The described embodiment and variations are examples of the invented concept that are not limitations thereto. The attached claims are intended to be the legal description of the invention.

I claim:

1. A high efficiency electric power generating system that includes a combination of a high efficiency motor vehicle and a household, where said high efficiency motor vehicle is parked for a substantial total time duration in a day in proximity to said household, where said high efficiency motor vehicle includes a low powered heat engine and an electric power generator driven by said low powered heat engine, where electric power produced is suitable for propulsion of said high efficiency motor vehicle, where said household has a capacity to use heat in heat using devices,
where there is an excess of heat that is a difference of heat produced in said heat engine by burning of fuel and a heat equivalent of electric energy generated, where said generating system includes heat transfer means that enables substantial transfer of said excess of heat to said household,
where said low powered heat engine produces a quantity of said excess of heat that does not significantly exceed said capacity to use heat, and said excess of heat replaces a like quantity of heat that is consequently not produced by burning fuel at a place other than in said heat engine for benefit of said household,
where said electric power generator produces electrical energy while said motor vehicle is in said proximity to said household, and said combination enables a distributed electric generating system that maximizes use of energy from burning fuel.

2. An electric power generating system according to claim 1 where said heat engine has a rated power output of less than 30 horsepower.

3. An electric power generating system according to claim 1 where said heat engine is regulated such that it has an average output power of less than 30 horsepower.

4. An electric power generating system according to claim 1 where said heat engine has a rated power output of less than 20 horsepower.

5. An electric power generating system according to claim 1 where said heat engine is regulated such that it has an average output power of less than 20 horsepower.

6. An electric power generating system according to claim 1 where said household includes heat storage apparatus that includes phase change material.

7. An electric power generating system according to claim 1 where said household includes cooling apparatus that is heat driven.

8. An electric power generating system according to claim 11 where said household includes cooling apparatus that is heat driven, where said cooling apparatus includes ice making capability that enables storage of cooling capacity that is derived from operation of said cooling apparatus.

9. An electric power generating system according to claim 1 where electric energy produced is use to charge batteries in said vehicle.

10. An electric power generating system according to claim 1 where electric energy produced is used to power equipment in said household.

11. An electric power generating system according to claim 1 where electric energy produced is exchanged on an electric utility network.

12. An electric power generating system according to claim 1 where fuel for said burning of fuel is delivered from said household, where said fuel is natural gas.

13. A high efficiency electric power generating system that includes a combination of a motor vehicle and a household, where said motor vehicle is parked for a substantial total time duration in a day in proximity to said household, where said motor vehicle includes a heat engine and an electric power generator driven by said heat engine, where said generator is capable of producing electric power that is suitable for propulsion of said motor vehicle, and where said household includes devices that have a capacity to use heat,
where there is an excess of heat that is a difference of heat produced in said heat engine by burning of fuel and a heat equivalent of electric energy generated, where said generating system includes heat transfer means that enables substantial transfer of said excess of heat to said household,
where said heat engine is operated under regulation such that it produces a quantity of said excess of heat that is used by said household instead of heat that would have otherwise been produced by burning fuel away from said heat engine for benefit of said household,
where said electric power generator produces electrical energy while said motor vehicle is in said proximity to said household,
where said combination enables approximately complete use of energy produced by burning fuel.

14. An electric power generating system according to claim 13 where said heat engine is regulated such that it has an average output power of less than 30 horsepower.

15. An electric power generating system according to claim 13 where said household includes heat storage apparatus that includes phase change material.

16. An electric power generating system according to claim 13 where said household includes cooling apparatus that is heat driven.

17. An electric power generating system according to claim 13 where electric energy produced is used to power equipment in said household.

18. An electric power generating system according to claim 13 where electric energy produced is exchanged on an electric utility network.

19. An electric power generating system according to claim 13 where engine coolant is routed through heat exchanging apparatus that enables removal of heat from said generator.

20. An electric power generating system according to claim 13 where fuel for said burning of fuel is delivered from said household, where said fuel is natural gas.

21. An electric power generating system according to claim 13 where said regulation includes a process of intermittent operation of said heat engine where said heat engine is caused to run for a fraction of the time such that said excess of heat is transferred at a rate that is useful to said household, but does not exceed said capacity of said household to use heat.

22. A high efficiency electric power generating system that includes a combination of a motor vehicle and a household, where said motor vehicle is parked for a substantial total time duration in a day in proximity to said household, where said motor vehicle includes a heat engine and an electric power generator driven by said heat engine, where said generator is capable of producing electric power that is suitable for propulsion of said motor vehicle, and where said household includes devices that have a capacity to use heat,
where there is an excess of heat that is a difference of heat produced in said heat engine by burning of fuel and a heat equivalent of electric energy generated, where said generating system includes heat transfer means that enables substantial transfer of said excess of heat to said household,
where said heat engine is operated under regulation such that it produces a quantity of said excess of heat that is used by said household instead of heat that would have otherwise been produced by burning fuel away from said heat engine for benefit of said household,
where said electric power generator produces electrical energy while said motor vehicle is in said proximity to said household,
where said combination enables a system efficiency in the use of energy that is substantially greater than the maximum thermal efficiency that can be practically achieved by a heat engine.
